(19) United States
(12) Patent Application Publication
(10) Pub. No.: US 2016/0093268 A1
(43) Pub. Date: Mar. 31, 2016

(54) IMAGE PROCESSING SYSTEM AND METHOD

(71) Applicants: National Taiwan University, Taipei (TW); HIMAX TECHNOLOGIES LIMITED, Tainan City (TW)

(72) Inventors: Kuang-Tsu Shih, Taipei (TW); Homer H. CHEN, Taipei (TW); Yi-Nung Liu, Tainan City (TW)

(21) Appl. No.: 14/501,038

(22) Filed: Sep. 30, 2014

(51) Int. Cl. G09G 5/02; G06T 5/00; G09G 5/30

(52) U.S. Cl. CPC G09G 5/02; G09G 5/30; G06T 5/009; G09G 2340/06; G09G 2320/066; G06T 2207/20208; G06T 2207/10024

(57) ABSTRACT

An image processing system and method include first processing a color stimulus relative to a first anchor, and then second processing a processed color stimulus relative to a second anchor. The first processing unit and the second processing unit preserve relative attributes of the color stimulus to enhance color sensation.

### BACKGROUND OF THE INVENTION

1. FIELD OF THE INVENTION

The present invention generally relates to an image processing system, and more particularly to an image processing system that exploits perceptual anchoring.

2. DESCRIPTION OF RELATED ART

As backlight module may consume 50% of the total power of a mobile multimedia device in video playing mode, reducing the power of the backlight module in a non-playing mode may thus save the total energy consumption and prolong the battery life. However, dim backlight degrades image quality in both luminance and chrominance. The importance of the need for compensating the undesirable effect caused by dim backlight cannot be overstated because of the increasing demand for high quality video and the rising environmental consciousness.

As an image is ultimately watched by human, the properties of human visual system (HVS) have to be taken into consideration for image enhancement. Because the perception of color is a psychological process, preserving color sensation across different image reproduction conditions is often more important than retaining the physical characteristics of color in many applications. This is especially the case for the enhancement of backlight-scaled images considered in this application. While most previous approaches are constrained to the luminance component, there is a need to compensate for the chrominance degradation and hence to avoid the unnatural color appearance caused by the mismatch between the luminance and the chrominance components.

Existing enhancement methods for backlight-scaled images can be classified into two categories. One category aims at preserving the luminance of pixels across different power levels of the backlight. Targeting primarily at energy saving, the methods of this category usually require that the local intensity of the backlight be controllable. The other category targets enhancing the visibility of images illuminated with dim backlight. One main drawback of the methods of this category is that the global contrast may not be preserved in the enhanced image.

### SUMMARY OF THE INVENTION

In view of the foregoing, it is an object of the embodiment of the present invention to provide a color image enhancement system that exploits perceptual anchoring. The embodiment is capable of faithfully reproducing the color appearance of images by preserving the relative perceptual attributes of the images.

According to one embodiment, an image processing system and method include a first processing unit configured to process a color stimulus relative to a first anchor; and a second processing unit configured to process a processed color stimulus from the first processing unit relative to a second anchor. The first processing unit and the second processing unit preserve relative attributes of the color stimulus to enhance color sensation.

### BRIEF DESCRIPTION OF THE DRAWINGS

FIG. 1 shows a block diagram illustrating an image processing system and method according to one embodiment of the present invention;

FIG. 2 shows a block diagram of a color image enhancement system that exploits perceptual anchoring according to one embodiment of the present invention;

FIG. 3 shows a specific embodiment of the color image enhancement system of FIG. 2; and

FIG. 4 generally shows typical inputs and outputs of a color appearance model that may be adapted to the embodiment of the present invention.

### DETAILED DESCRIPTION OF THE INVENTION

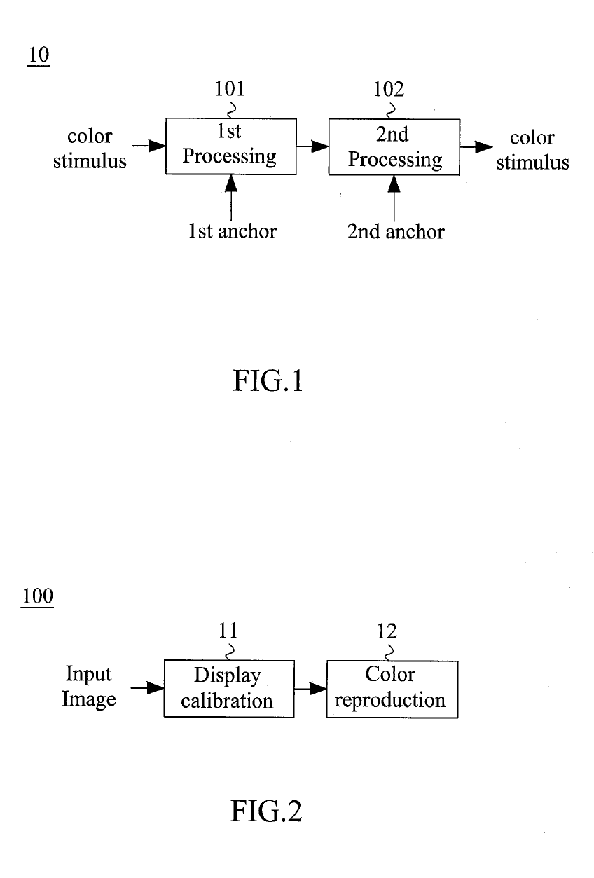

FIG. 1 shows a block diagram illustrating an image processing system and method 10 according to one embodiment of the present invention. In the embodiment, a color stimulus (of an input image) is first processed relative to a first anchor in block 101. Subsequently, the processed color stimulus from block 101 is subjected to second processing relative to a second anchor in block 102, thereby generating a processed color stimulus (of an output image). According to one aspect of the embodiment, color sensation is preserved through the processing in blocks 101 and 102 in a way that matches human perception. The term “anchor” defined in anchoring property of human visual system (HVS) is adopted in this specification.

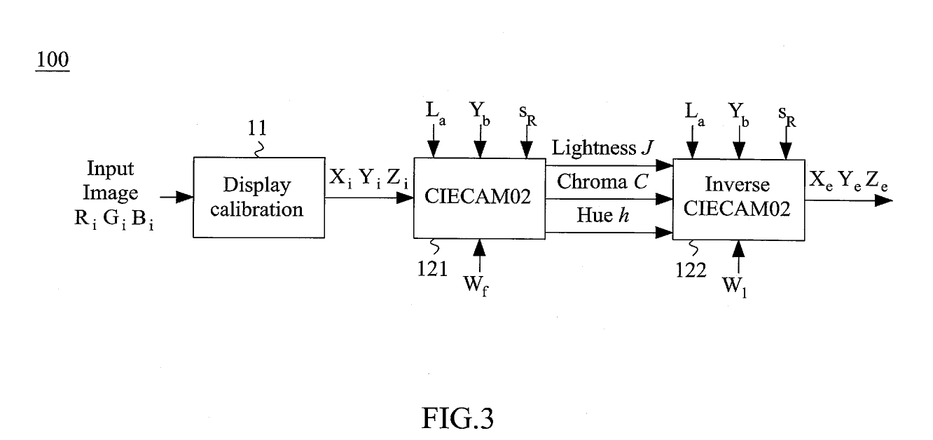

For better understanding aspects of the present invention, a color image enhancement system 100 that exploits perceptual anchoring according to one embodiment of the present invention is illustrated in FIG. 2. In the embodiment, the color image enhancement system 100 includes two main blocks, namely, display calibration 11 and color reproduction 12, which may be performed by a processor such as a digital image processor. FIG. 3 shows a specific embodiment of the color image enhancement system 100, which will be described in detail in the following sections.

The display calibration 11 of the embodiment is aimed at device (e.g., a liquid crystal display (LCD)) characteristic modeling, which involves the estimation of the relation between an input pixel value (of an input image) and a resulting color. Specifically, the display calibration 11 is configured to transfer the input pixel value from a device-dependent RGB space to a device-independent XYZ color space. The relation between the input pixel value and the resulting color may be expressed as follows:

$$[ \begin{matrix}X \\ Y \\ Z\end{matrix} ] = M [ \begin{matrix}{R}_{l} \\ {G}_{l} \\ {B}_{l}\end{matrix} ] = [ \begin{matrix}{m}_{rx} & {m}_{gx} & {m}_{bx} \\ {m}_{ry} & {m}_{gy} & {m}_{by} \\ {m}_{rz} & {m}_{gz} & {m}_{bz}\end{matrix} ] [ \begin{matrix}{R}^{{γ}_{r}} \\ {G}^{{γ}_{g}} \\ {B}^{{γ}_{b}}\end{matrix} ] \qquad ( 1 )$$

where γᵣ, γ_{g} and γ_{b}, respectively, denote the gamma values of the red, green, and blue channels, (R, G, B) denotes the normalized device-dependent pixel value in the input image, (Rₗ, Gₗ, Bₗ) denotes the linear RGB value, (X, Y, Z) denotes the resulting XYZ tristimulus value, and M denotes the transformation matrix.

The calibration is performed for the full-backlight display and the low-backlight display. In the specification, the low-backlight has a power, for example, less than half of the full-backlight, and may be as low as 5% of the full-backlight. The resulting transformation matrices for the full-backlight and the low-backlight displays are denoted by M_{f} and Mₗ, respectively. The resulting estimated gammas are denoted by γ_{r,f}, γ_{g,f}, and γ_{b,f} for the full-backlight display and γ_{r,l}, γ_{g,l}, and γ_{b,l} for the low-backlight display. The XYZ tristimulus value (Xᵢ, Yᵢ, Zᵢ) of an arbitrary pixel in the original image is obtained from the RGB value (Rᵢ, Gᵢ, Bᵢ) by substituting (R, G, B)=(Rᵢ, Gᵢ, Bᵢ), γᵣ=γ_{r,f}, γ_{g}=γ_{g,f}, γ_{b}=γ_{b,f}, and M=M_{f} into (1).

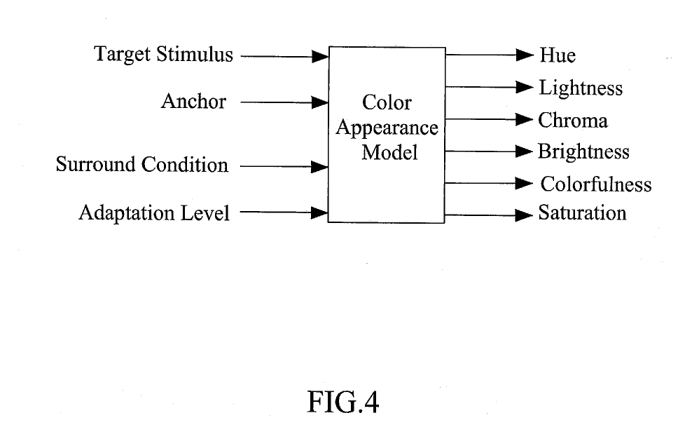

The color reproduction 12 of the embodiment includes a color appearance model (CAM) transformation unit 121 and an inverse CAM transformation unit 122, for the full-backlight display and the low-backlight display, respectively. The term “unit” in the specification refers to a structural or functional entity that may be performed, for example, by circuitry such as a digital image processor. A color appearance model is more appropriate for color specification in a way that matches human perception. FIG. 4 generally shows typical inputs and outputs of a color appearance model that may be adapted to the embodiment of the present invention. The inputs include the XYZ tristimulus value of the target color along with a set of parameters (such as the anchor, the surround condition and the adaptation level) describing the viewing condition. On the other hand, the outputs are the predictors of the color appearance attributes: hue, lightness, brightness, chroma, colorfulness, and saturation, where the lightness, hue, and chroma are relative attributes, while brightness, colorfulness and saturation are absolute attributes. The color reproduction 12 of the embodiment aims to preserve the relative attributes of lightness, chroma, and hue using the color appearance model. CIECAM02, a color appearance model published in 2002 and ratified by the International Commission on Illumination (CIE) Technical Committee, is adopted in the embodiment to compute the relative perceptual attributes (i.e. lightness, chroma, and hue). However, any invertible color appearance model capable of predicting these attributes can be used instead.

HVS judges the appearance of color with respect to an anchor. Anchoring is essential to human color perception and to this application. For the same physical stimulus, the perceptual response becomes higher when the anchor is at a lower level. As a consequence of the anchoring property of HVS, when the backlight intensity is lowered, HVS tends to overestimate the light emitted from the color patch, resulting in a higher perceptual response.

Regarding the CAM transformation unit 121, as shown in FIG. 3, the inputs are the XYZ tristimulus value of the target, the luminance of the adaptation field Lₐ, the luminance of the background field Y_{b}, and the surround condition s_{R}. The outputs are the three relative attributes of color perception, that is, the lightness, hue, and chroma. In the embodiment, we first compute the XYZ value of the anchor for the full-backlight display W_{f} by setting R==B=1, (γᵣ, γ_{g}, γ_{b})=(65 _{r,f}, γ_{g,f}, γ_{b,f}), and M=M_{f} in (1). Generally speaking, W_{f} is the largest tristimulus value for a full-backlight display. Note that the full-backlight anchor W_{f} serves as the anchor input to the CAM transformation unit 121.

Regarding the inverse CAM transformation unit 122, as shown in FIG. 3, the inputs are the lightness J, chroma C, hue h, the luminance of the adaptation field Lₐ, the luminance of the background field Y_{b}, and the surround condition s_{R}. The outputs are the enhanced XYZ value. In the embodiment, we obtain the anchor for the low-backlight display Wₗ by setting R=G=B=1, (γᵣ, γ_{g}, γ_{b})=(γ_{r,l}, γ_{g,l}, γ_{b,l}), and M=Mₗ in (1). Next, we obtain the relative attributes (lightness J, chroma C, and hue h) from the

CAM transformation unit 121. Generally speaking, Wₗ is the largest tristimulus value for a low-backlight display. Note that the low-backlight anchor Wₗ serves as the anchor input to the inverse CAM transformation unit 122.

The enhanced XYZ value may be subjected to further processing, for example, a color transformation (not shown) that transforms the enhanced XYZ value from the XYZ space to the RGB space.

According to the embodiment illustrated above, a method to enhance the color appearance of images illuminated with dim LCD backlight is described. Rooted on the anchoring property of HVS, our method faithfully reproduces the color appearance of images by preserving the relative perceptual attributes of the images.

Although specific embodiments have been illustrated and described, it will be appreciated by those skilled in the art that various modifications may be made without departing from the scope of the present invention, which is intended to be limited solely by the appended claims.

What is claimed is:

1. An image processing system, comprising:
a first processing unit configured to process a color stimulus relative to a first anchor; and
a second processing unit configured to process a processed color stimulus from the first processing unit relative to a second anchor;
wherein the first processing unit and the second processing unit preserve relative attributes of the color stimulus to enhance color sensation.

2. The system of claim 1, wherein the first processing unit and the second processing unit comprise:
a color appearance model (CAM) transformation unit coupled to receive a tristimulus value with the first anchor associated with a first power of a backlight, thereby generating a plurality of color appearance attributes; and
an inverse CAM transformation unit that is an inverse of the CAM transformation unit, the inverse CAM transformation unit being coupled to receive the plurality of color appearance attributes with the second anchor associated with a second power of the backlight, thereby generating an enhanced tristimulus value.

3. The system of claim 2, wherein the CAM transformation unit comprises CIECAM02, a color appearance model ratified by the International Commission on Illumination (CIE) Technical Committee.

4. The system of claim 2, wherein the first anchor inputted to the CAM transformation unit is an approximately largest tristimulus value at the first power.

5. The system of claim 2, wherein the second anchor inputted to the inverse CAM transformation unit is an approximately largest tristimulus value at the second power.

6. The system of claim 2, wherein the plurality of color appearance attributes comprise lightness, hue, and chroma.

7. The system of claim 2, wherein the CAM transformation unit or the inverse CAM transformation unit further receives luminance of an adaptation field, luminance of a background field, and a surround condition.

8. The system of claim 2, further comprising a display calibration unit coupled to receive an input image, and configured to transfer an input pixel of the input image from a device-dependent color space to a device-independent color space.

9. The system of claim 8, wherein the device-dependent color space is RGB (red, green and blue) color space, and the device-independent color space is XYZ color space.

10. A method of image processing, comprising:
(a) first processing a color stimulus relative to a first anchor; and
(b) second processing a processed color stimulus from the step (a) relative to a second anchor;
wherein the steps (a) and (b) preserve relative attributes of the color stimulus to enhance color sensation.

11. The method of claim 10, wherein the steps (a) and (b) comprise:
performing a color appearance model (CAM) transformation step that processes a tristimulus value with the first anchor associated with a first power of a backlight, thereby generating a plurality of color appearance attributes; and
performing an inverse CAM transformation step that is an inverse of the CAM transformation step, the inverse CAM transformation step processing the plurality of color appearance attributes with the second anchor associated with a second power of the backlight, thereby generating an enhanced tristimulus value.

12. The method of claim 11, wherein the CAM transformation step is performed by using CIECAM02, a color appearance model ratified by the International Commission on Illumination (CIE) Technical Committee.

13. The method of claim 11, wherein the first anchor inputted in the CAM transformation step is an approximately largest tristimulus value at the first power.

14. The method of claim 11, wherein the second anchor inputted in the inverse CAM transformation step is an approximately largest tristimulus value at the second power.

15. The method of claim 11, wherein the plurality of color appearance attributes comprise lightness, hue, and chroma.

16. The method of claim 11, wherein the CAM transformation step or the inverse CAM transformation step further receives luminance of an adaptation field, luminance of a background field, and a surround condition.

17. The method of claim 11, further comprising a display calibration step that transfers an input pixel of an input image from a device-dependent color space to a device-independent color space.

18. The method of claim 17, wherein the device-dependent color space is RGB (red, green and blue) color space, and the device-independent color space is XYZ color space.
